(19) United States
(12) Patent Application Publication
(10) Pub. No.: US 2017/0327369 A1
(43) Pub. Date: Nov. 16, 2017

(54) SENSOR TECHNOLOGY FOR FLUID HANDLING PRODUCTS

(71) Applicant: DES-CASE CORPORATION, Goodlettsville, TN (US)

(72) Inventors: Keith Mawdsley, Hendersonville, TN (US); Nikhil Gaikwad, Goodlettsville, TN (US); Mark Barnes, Vancouver (CA); Jonathan Haworth, Hendersonville, TN (US)

(21) Appl. No.: 15/595,461

(22) Filed: May 15, 2017

Related U.S. Application Data
(60) Provisional application No. 62/336,785, filed on May 16, 2016.

(51) Int. Cl. B67D 7/16; B67D 7/56; B67D 7/12; B67D 7/84; B67D 7/04

(52) U.S. Cl. CPC B67D 7/16; B67D 7/84; B67D 7/04; B67D 7/12; B67D 7/565

(57) ABSTRACT

An oil drum adapter kit may be used for connection to an oil drum containing oil. The oil drum adapter kit may include an adapter body. A fill tube may be connected to the adapter body to allow the oil drum to be filled with the oil. A drain tube may be connected to the adapter body to allow the oil to be removed from the oil drum. A level sensor may be disposed on the drain tube. The level sensor may be configured to sense a level of the oil contained in the oil drum.

### BACKGROUND

The present disclosure relates generally to fluid handling products. More particularly, the present disclosure pertains to utilizing one or more sensors in conjunction with oil storage containers and machines utilizing oil.

Containers and machines used in manufacturing and other fields of endeavor utilize fluids for lubrication such as oils and other substances. It is important that these fluids be kept to quality standards with regard to acceptable amounts of particulate and water contamination. Too much contamination can result in degradation of the oil and even potentially damage to machinery utilizing the oil.

Previous methods of monitoring oil properties involve taking a sample of the oil to be monitored. This sampling can sometimes require halting the operation of the manufacturing process. Oil sight glasses have been used to monitor the fluid properties of operating machines without shutting down the machine, but these prior oil sight glasses require human inspection at the location of the machine according to a set schedule. Furthermore, a person may need a flashlight or a well-lit area to properly inspect the oil sight glass. With regard to monitoring the properties of oil in a drum, tote, or container other than the housing of machinery, sampling is required.

The function of an oil sight glass is to provide visual confirmation of water and/or debris in oil. The oil may be stored in a reservoir, and the oil sight glass may be connected to the reservoir. Oil reservoirs may be used to feed gearboxes, hydraulic systems, and lubrication systems. Because of wear, water, particulates, heat, and other factors, the oil becomes contaminated. This contamination may migrate to the reservoir and may settle at the bottom as sediment.

Traditional oil sight glasses may also include bottom sediment and water bowls. These oil sight glasses include a drain at the bottom to aid in the evacuation of sediment or water from the bottom of the reservoir. The oil sight glass can be installed in either a horizontal or a vertical orientation. In many situations, the color of the oil and other factors make distinguishing between oil and water in the sight glass quite difficult. Also, oil sight glasses are often mounted in difficult to access or difficult to see places. Nonetheless, a user would have to visually inspect the oil sight glass on a regular basis. Also, the oil sight glass must remain relatively clean from dust or other contaminants on the outside of the oil sight glass such that a user may still visually inspect the contents of the oil sight glass. Water baths or weak acid baths may be utilized to clean off the oil sight glass at regular intervals, potentially damaging any external components of the oil sight glass.

These previous methods can be time-consuming and inefficient, leading to unnecessary costs. What is needed, therefore, is a more efficient manner of monitoring characteristics of the oil in a container, whether that container is a machine housing, a drum, a tote, or some other vessel.

### BRIEF SUMMARY

Briefly, the present disclosure relates, in one embodiment, to an oil drum adapter kit which may be used for connection to an oil drum containing oil. The oil drum adapter kit may include an adapter body. A fill tube may be connected to the adapter body to allow the oil drum to be filled with the oil. A drain tube may be connected to the adapter body to allow the oil to be removed from the oil drum. A level sensor may be disposed on the drain tube. The level sensor may be configured to sense a level of the oil contained in the oil drum.

In any embodiment, the level sensor may be disposed on the outside of the drain tube.

In any embodiment, the level sensor may be disposed on the inside of the drain tube.

In any embodiment, the level sensor may include a float configured to float on a surface of the oil. An elongate indication member may be connected to the float. The elongate indication member may extend along the drain tube and beyond the adapter body to indicate the level of the surface of the oil in the oil drum.

In any embodiment, the drain tube may include a drain tube wall. An indication member passage may be defined in the drain tube wall. The elongate indication member may extend through the indication member passage.

In any embodiment, the adapter body may include a drum side and an exterior side opposite the drum side. The drain tube may further include an indication member opening nearer the drum side of the adapter body than the exterior side. The elongate indication member may extend through the indication member opening.

In any embodiment, the float may be disposed in the indication member passage. The indication member passage may include an oil inlet opening defined in the drain tube wall such that the oil may enter the indication member passage and interact with the float.

In any embodiment, the indication member passage may include a channel defined in the drain tube wall.

In any embodiment, the level sensor may include a magnet configured to float on a surface of the oil. The level sensor may further include at least one magnetic reed switch disposed along the drain tube. The at least one magnetic reed switch may be configured to open or close a circuit in the presence of the magnet.

In any embodiment, a flow sensor may be disposed inside the fill tube.

In any embodiment, a relative humidity sensor may be connected to the adapter body to sense relative humidity in a headspace of the oil drum when the adapter kit is mounted on the oil drum.

In any embodiment, a breather may be connected to the fill tube. The breather may include a breather port. A switch may be configured to indicate whether the breather port is open or closed.

In any embodiment, the switch may be further configured to indicate whether the breather has been removed or manipulated.

The present disclosure also relates, in one embodiment, to an oil tote adapter kit for connection to an oil tote containing oil. The oil tote adapter kit may include an adapter body. A fill tube may be connected to the adapter body to allow the oil tote to be filled with the oil. A drain tube may be connected to the adapter body to allow the oil to be removed from the oil tote. A first pressure sensor may be disposed on the drain tube. The first pressure sensor may be configured to sense a pressure experienced due to the level of oil in the oil tote.

In any embodiment, the oil tote adapter kit may also include a controller configured to receive a density of the oil as an input and to convert the pressure experienced by the first pressure sensor to an oil level contained in the oil tote.

In any embodiment, a breather may be connected to the fill tube. The breather may include at least one check valve. A second pressure sensor may be disposed on the adapter body. The second pressure sensor may be configured to sense a pressure in a headspace of the oil tote. The controller may be further configured to compare results of the first pressure sensor and the second pressure sensor to account for the breather and the at least one check valve in calculating the oil level contained in the oil tote.

In any embodiment, a flow sensor may be disposed inside the fill tube.

In any embodiment, a relative humidity sensor may be connected to the adapter body to sense relative humidity in a headspace of the oil tote when the adapter kit is mounted on the oil tote.

In any embodiment, a breather may be connected to the fill tube. The breather may include a breather port. A switch may be configured to indicate whether the breather port is open or closed.

In any embodiment, the switch may be further configured to indicate whether the breather has been removed or manipulated.

The present disclosure also relates, in one embodiment, to a hydraulic or gearbox adapter kit for connection to a hydraulics system or gearbox containing oil. The hydraulic or gearbox adapter kit may include an adapter body. A fill tube may be connected to the adapter body to allow the hydraulics system or gearbox to be filled with oil. A drain tube may be connected to the adapter body to allow the oil to be removed from the hydraulics system or gearbox. A breather may be connected to the adapter body. A pressure sensor may be disposed on the adapter body and configured to detect a pressure inside the hydraulics system or gearbox and indicate if the breather is functioning below a preset threshold value.

In any embodiment, a flow sensor may be disposed inside the fill tube.

In any embodiment, the breather may include a breather port. A switch may be configured to indicate whether the breather port is open or closed.

In any embodiment, the switch may be further configured to indicate whether the breather has been removed or manipulated.

In any embodiment, a relative humidity sensor may be connected to the adapter body to sense relative humidity in a headspace of the hydraulics system or gearbox when the adapter kit is mounted on the hydraulics system or gearbox.

In any embodiment, the pressure sensor may include a vacuum sensor.

The present disclosure also relates, in one embodiment, to a drain port adapter kit for connection to industrial equipment. The drain port adapter kit may include an adapter body. A drain tube may be connected to the adapter body to allow the oil to be removed from the industrial equipment. A pressurizing breather may be configured to be in fluid communication with air in a headspace of the industrial equipment. A first pressure sensor may be disposed on the drain tube. The first pressure sensor may be configured to sense a pressure experienced due to the oil in the industrial equipment. A second pressure sensor may be configured to sense a pressure in the headspace. A controller may be configured to compare pressures sensed by the first pressure sensor with pressures sensed by the second pressure sensor to correct for any pressure differences in the headspace due to the pressurizing breather.

In any embodiment, the controller may be further configured to receive a density of the oil as an input and to calculate the level of the oil in the industrial equipment based on the pressures sensed by the first pressure sensor and the pressures sensed by the second pressure sensor.

The present disclosure also relates, in one embodiment, to an oil sight glass for monitoring oil in a container. The oil sight glass may include a sight glass body. The sight glass body may include a transparent material. A threaded connector may be disposed on the sight glass body. The threaded connector may be configured to attach the sight glass to the container. A drain port may be defined in the sight glass body. A drain port valve may be connected to the sight glass body to open and close the drain port. A cavity may be defined in the sight glass body. The cavity may be configured to contain a sample of the oil. A sensor may be contained in the cavity and unattached from the sight glass body. The sensor may be configured to remain at least partially submerged in the sample of the oil.

In any embodiment, the sensor may be a battery powered wireless sensor.

In any embodiment, the sensor may include a moisture sensor configured to detect a percentage of moisture in the sample of the oil.

In any embodiment, the moisture sensor may be configured to detect moisture due to contamination of the sample of the oil with dissolved or emulsified water.

In any embodiment, the sensor may include a temperature sensor configured to detect a temperature of the sample of the oil.

The present disclosure also relates, in one embodiment, to an oil sight glass for monitoring oil and water in a container. The oil sight glass may include a sight glass body. The sight glass body may include a transparent material. A threaded connector may be disposed on the sight glass body. The threaded connector may be configured to attach the sight glass to the container. A drain port may be defined in the sight glass body. A drain port valve may be connected to the sight glass body to open and close the drain port. A cavity may be defined in the sight glass body. The cavity may be configured to contain a sample of the oil and the water. A sensor may be at least partially disposed in the cavity. At least a portion of the sensor may be configured to float on free water and sink in the oil.

In any embodiment, the sensor may be configured to maintain an upright orientation. The sensor may include a moisture sensor configured to detect a percentage of moisture in the sample of the oil. The moisture sensor may be further configured to remain submerged in the oil when the sensor is in the upright orientation.

In any embodiment, the moisture sensor may be configured to detect moisture due to contamination of the sample of the oil with dissolved or emulsified water.

In any embodiment, the sensor may include a floating component configured to float on the free water and sink in the oil. The sensor may also include a stationary component mounted to the sight glass body.

In any embodiment, the floating component may include an RFID chip and the stationary component may include at least one RFID sensor.

In any embodiment, the floating component may include a magnet and the stationary component may include at least one magnetic reed switch.

In any embodiment, the threaded connector includes a minimum passage width. The floating component may be larger than the minimum passage width.

The present disclosure also relates, in one embodiment, to an oil sight glass assembly for mounting to a port of a container with oil therein. The oil sight glass assembly may include an extension tube to mount to the container at the port. The extension tube may include an internal passageway. At least one sensor may be configured to extend into the internal passageway of the extension tube. A sight glass body may be connected to the extension tube. The sight glass body may include a transparent material. A drain port may be defined in the sight glass body. A drain port valve may be connected to the sight glass body to open and close the drain port.

In any embodiment, the sensor may include a temperature sensor configured to detect a temperature of the sample of the oil.

In any embodiment, the sensor may include a moisture sensor configured to detect a percentage of moisture in the sample of the oil.

In any embodiment, the moisture sensor may be configured to detect moisture due to contamination of the sample of the oil with dissolved or emulsified water.

### BRIEF DESCRIPTION OF THE DRAWINGS

FIG. 1 is a schematic view of a flow diagram including one embodiment of a sensor configuration.

FIG. 2 is an isometric view of a filter cart for use with the sensor configuration of FIG. 1.

FIG. 3 is an isometric view of a drum topper for use with the sensor configuration of FIG. 1.

FIG. 4 is an isometric view of a drum filter cart for use with the sensor configuration of FIG. 1.

FIG. 5 is a schematic view of a flow diagram including another embodiment of a sensor configuration.

FIG. 6 is an isometric view of a panel unit for use with the sensor configuration of FIG. 5.

FIG. 7 is an isometric view of a compact panel unit for use with the sensor configuration of FIG. 5.

FIG. 8 is a schematic view of a flow diagram including yet another embodiment of a sensor configuration.

FIG. 9 is an isometric view of a cart for use with the sensor configuration of FIG. 8.

FIG. 10 is an isometric view of a stand for use with the sensor configuration of FIG. 8.

FIG. 11 is a schematic view of a flow diagram including a further embodiment of a sensor configuration.

FIG. 12 is an isometric view of an LT-Series lubricant management system for use with the sensor configuration of FIG. 11.

FIG. 13 is an isometric view of a drum adapter kit.

FIG. 14 is a side elevation view of the drum adapter kit of FIG. 13.

FIG. 15 is a cross-sectional elevation view of a drum adapter kit.

FIG. 16 is a cross-sectional elevation view of another drum adapter kit.

FIG. 17 is a cross-sectional elevation view of yet another drum adapter kit.

FIG. 18 is a cross-sectional elevation view of still another drum adapter kit.

FIG. 19 is a cross-sectional elevation view of the drum adapter kit of FIG. 18 with the elongate indication member extended.

FIG. 20 is a cross-sectional front elevation view of another drum adapter kit.

FIG. 21 is a detailed cross-sectional side elevation view of the drum adapter kit of FIG. 20.

FIG. 22 is an isometric view of a tote adapter kit.

FIG. 23 is a side elevation view of the tote adapter kit of FIG. 22.

FIG. 24 is a cross-sectional elevation view of the tote adapter kit of FIG. 22.

FIG. 25 is an isometric view of a hydraulic/gearbox adapter kit.

FIG. 26 is a side elevation view of the hydraulic/gearbox adapter kit of FIG. 25.

FIG. 27 is a cross-sectional elevation view of the hydraulic/gearbox adapter kit of FIG. 25.

FIG. 28 is an isometric view of a drain port adapter kit.

FIG. 29 is an isometric view of an embodiment of an oil sight glass.

FIG. 30 is an isometric view of another embodiment of an oil sight glass.

FIG. 31 is an isometric view of yet another embodiment of an oil sight glass.

FIG. 32 is an isometric view of an oil sight glass assembly.

FIG. 33 is an isometric view of still another embodiment of an oil sight glass.

FIG. 34 is an isometric view of a container and corresponding dispensing lid.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The term “sight glass” should be interpreted to mean an apparatus allowing visual inspection of oil in the apparatus. The inclusion of the word “glass” should not place any limits on the components used in the manufacture of the apparatus. The apparatus may be made in whole or in part of glass, but the apparatus may additionally or alternatively be made of polymers, metals, or other materials. Additionally, while the term “oil sight glass” is utilized, the sight glass in various optional embodiments may be used with oil and water, but also may be used with a variety of other fluids as well. As used herein, “oil sight glass” and “sight glass” are understood to be interchangeable.

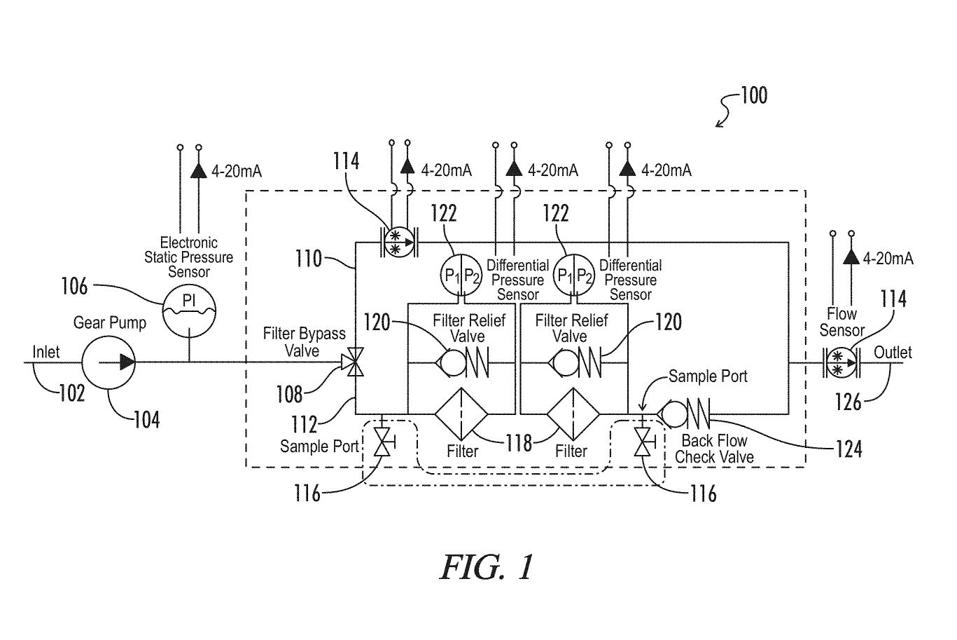

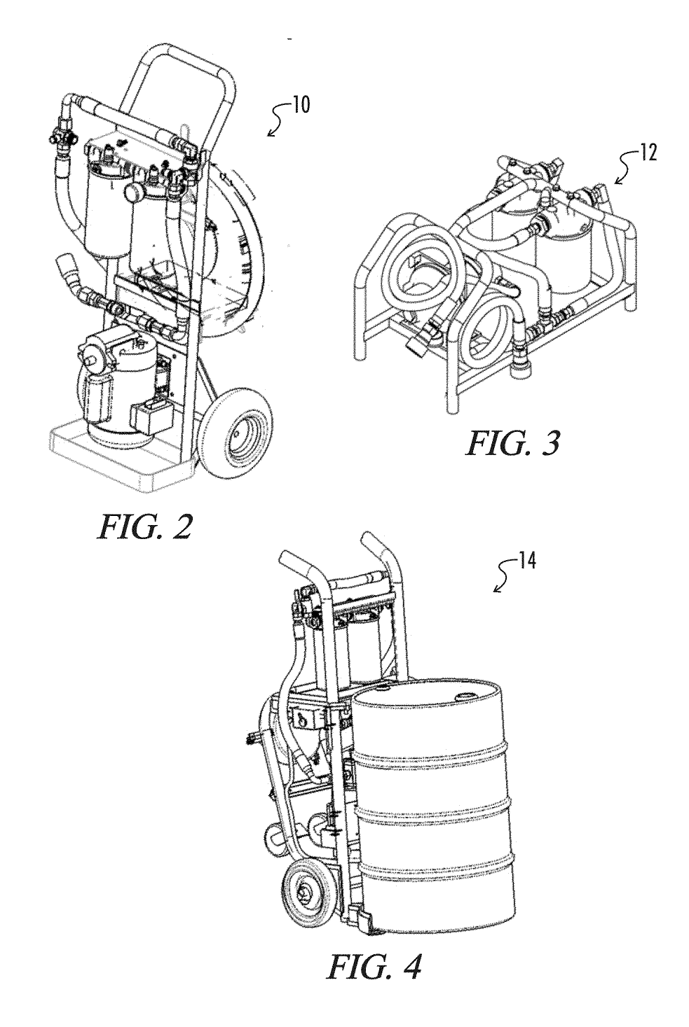

Referring to FIG. 1, a flow system 100 for devices such as filter carts 10 (as shown in FIG. 2), drum toppers 12 (as shown in FIG. 3), and drum filter carts 14 (as shown in FIG. 4) is shown. Fluid may flow through the flow system 100, passing through and/or past downstream components as the fluid proceeds in a path from the inlet 102 to the outlet 126. As shown in FIG. 1, fluid may enter the flow system 100 via the inlet 102. As fluid proceeds from the inlet 102, the fluid may be forced onward by a pump 104. The pump 104 may be any suitable pumping mechanism including, but not limited to, a gear pump. A pressure sensor, such as an electronic static pressure sensor 106, may be located in the flow path of the fluid after the pump 104. Downstream from the pressure sensor 106, the system 100 may include a filter bypass valve 108. The filter bypass valve 108 may be connected to a first branch 110 and a second branch 112 of the flow system 100. The first branch 110 may include the filter bypass path. The first branch 110 may further include a flow sensor 114. The second branch 112 may include at least one sample port 116 such that a user may take a sample of the fluid in the flow system 100. The second branch 112 may also include one or more filters 118. The flow system 100 may further include a filter relief valve 120 connected to the second branch 112 in parallel with a corresponding filter 118. A differential pressure sensor 122 may be configured to detect the fluid flow pressure both before and after the corresponding filter 118. Downstream from the one or more filters 118, a back flow check valve 124 may be disposed in the second branch 112. Both the first branch 110 and the second branch 112 may meet upstream of another flow sensor 114. The fluid may exit the flow sensor 114 and proceed to an outlet 126.

The pressure sensor 106 may also be located in the flow path of the fluid upstream of a first filter 108. The location of the pressure sensor 106 may measure the highest pressure in the system 100. Pressure lower than a threshold pressure sensed by the pressure sensor 106 may, in some embodiments, indicate issues such as restricted fluid flow, a problem with the pump 104, or a filter 118 that is not properly sealed. Pressure that is higher than a threshold pressure sensed by the pressure sensor 106 may indicate the filters 118 have exceeded their capacity, a clog in the system 100, or flow is restricted at the outlet 126. The reading output from the pressure sensor 106 may serve as a warning indicator in embodiments that are configured to automatically shut off when the pressure becomes higher than a threshold pressure.

The differential pressure sensor 122 may be configured to indicate when the pressure drop is more than a threshold pressure drop, such as 22 psi for example. In some embodiments, the differential pressure sensor 122 may indicate the need to change the corresponding filter 118 when the pressure drop exceeds the threshold pressure drop. The differential pressure sensor 122 may include one or more pressure sensing components such that the differential pressure sensor may detect the pressure both before and after a corresponding filter 118. Some embodiments may include a differential pressure sensor 122 comprised of multiple electrically or functionally connected pressure sensors.

Additionally or alternatively to the flow sensor 114 near the outlet 126, a flow sensor may be located upstream of the pump 104. A flow sensor 114 upstream from the pump 104 may, in some embodiments, indicate whether the suction of the pump is appropriate. Such information may aid a user in troubleshooting the flow system 100 or determining if any components upstream from the flow sensor 114 are clogged or dysfunctional. A flow sensor 114 near the outlet 126 may, in some embodiments, indicate any flow stoppage occurring due to the flow system 100 as opposed to an attached nozzle or other component downstream of the outlet.

The flow sensor 114 located in the first branch 110, or a bypass flow sensor, may be configured, in some embodiments, to indicate if the flow system 100 is in a bypass mode or, alternatively, in a filter mode. Such a configuration may be beneficial in exemplary embodiments including fluid passages that are not transparent or translucent.

A particle counter (not shown) may be disposed both before and after each corresponding filter 118. The particle counter may be configured to measure the size and number of particles in a given sample taken from the fluid in the flow system 100 at the respective location. Such a configuration may, in some non-limiting examples, aid in determining if the fluid is clean enough for reliable operation or use. A particle counter disposed upstream of a corresponding filter 118 may provide an indication of the conditions in the equipment and the conditions of the incoming fluid. A particle counter disposed downstream of a corresponding filter 118 may provide an indication of filter performance.

A magnetic wear debris sensor (not shown) may be disposed near one or both of the inlet 102 and the outlet 126. In some embodiments, the magnetic wear debris sensor may be located in a passageway upstream of the inlet 102 or in a passage downstream of the outlet 126. In some embodiments, the magnetic debris sensor may be configured to detect iron and other magnetic particles in the fluid passing through the flow system 100. The magnetic debris sensor may be configured, in combination with the above mentioned particle counter, to provide the user with an indication the particle count is a result of either outside contamination of the fluid or wear on the internal components of the equipment connected to the flow system 100. In some embodiments, the magnetic wear debris sensor may include a Hall Effect sensor.

A dielectric sensor (not shown) may be disposed near one or both of the inlet 102 and the outlet 126. In some embodiments, the dielectric sensor may be located in a passageway upstream of the inlet 102 or in a passage downstream of the outlet 126. The dielectric sensor may be configured to measure impedance of the fluid flowing in the passage. The dielectric sensor may be further configured to monitor the change of the fluid impedance over time. Changes in the dielectric constant of the fluid may indicate, in some embodiments, the presence of contaminants, changes in chemistry of the fluid such as additive depletion, oxidation, and the like. The measured dielectric constant of the fluid could be used to identify the type of fluid flowing through the flow system 100. In embodiments utilizing oil as the fluid, the measured dielectric constant could be used to identify the type of oil including, but not limited to, mineral, PAG (polyalkylene glycol), phosphate ester, POE (polyolester), PAO (poly alfa olefin), and the like. An increase in the dielectric constant of the oil could indicate oxidation, water contamination, and particulate contamination. Cross-contamination could quickly and easily be identified in some embodiments with the use of the dielectric sensor.

Some embodiments of the flow system 100 may include a controller (not shown). The controller may receive all the sensed values from the various sensors and output various corresponding alerts, readings, and other calculations. In one embodiment, the controller may include a global positioning system function so as to identify and report the location of the flow system 100 and any connected equipment.

The exterior frame (not shown) or other exterior portions of the flow system 100 may also include one or more forms of electronic tagging or surface indicia, such as RFID, one or more controllers configured to wirelessly communicate, bar codes, and the like. The tagging system may provide a list of compatible equipment and machines when a tag on or in the flow system 100 communicates with another device or is scanned. Some embodiments including the tagging system configured to aid in preventing cross-contamination of the equipment and/or oils.

A moisture sensor (not shown) may also be disposed in the flow system 100 in one or more of the inlet 102 and the outlet 126. In some embodiments, the moisture sensor may be configured to measure the percentage of water in the oil. A moisture sensor located upstream from the filters 118 may provide an indication of the conditions in the equipment while a moisture sensor located downstream of the filters may provide an indication of filter performance for water removal filters.

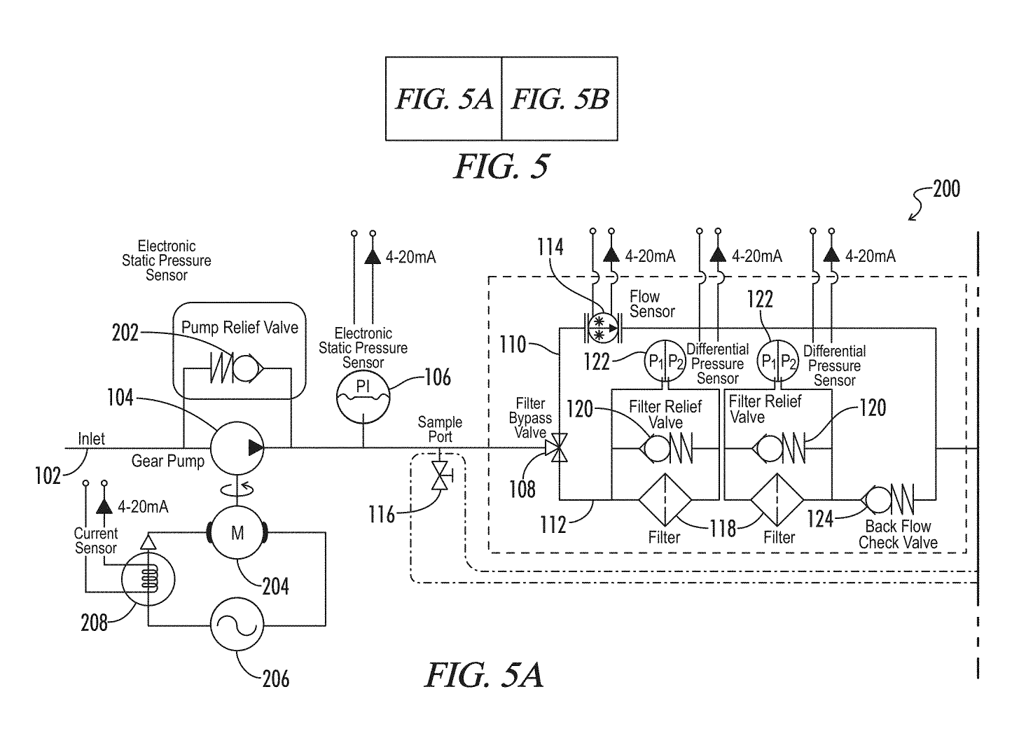

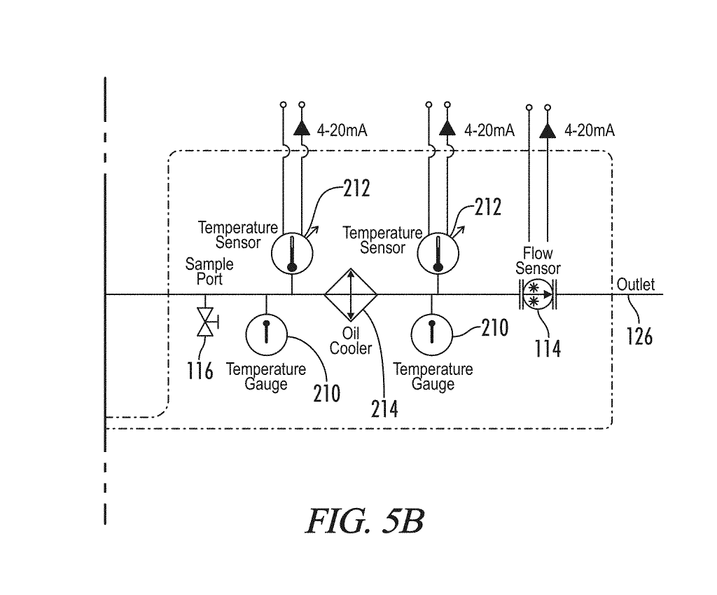

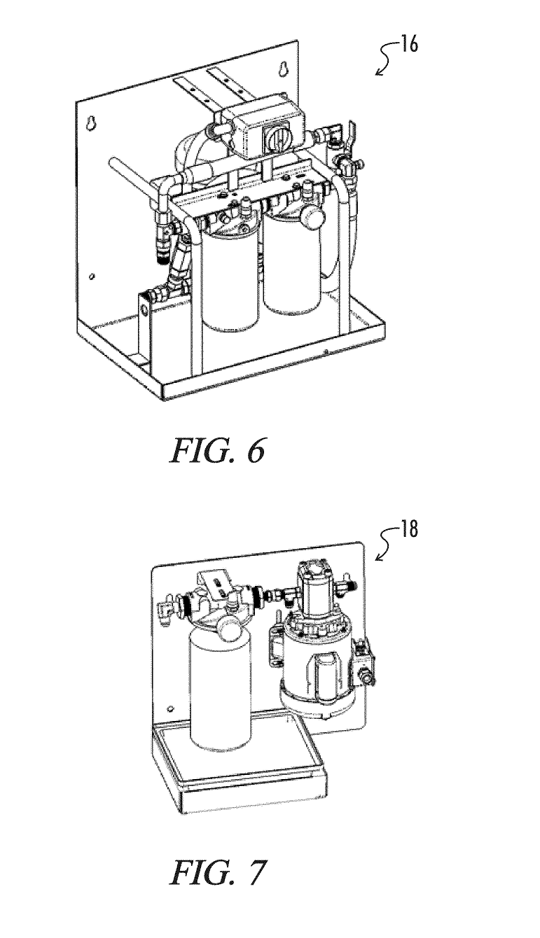

Referring now to FIG. 5, a flow system 200 for devices such as panel units 16 (as shown in FIG. 6) and compact panel units 18 (as shown in FIG. 7) is shown. As shown in FIG. 5, fluid may enter the flow system 200 through the inlet 102. A pump 104 may be located downstream of the inlet 102. The flow system 200 may further include a pump relief valve 202 connected in parallel with the pump 104. The pump relief valve 202 may be configured to alleviate excessive pressure produced downstream of the pump 104 due to a clog or some other pressure increasing condition. In some embodiments, the pump 104 may be driven either directly or indirectly by a motor 204. Some embodiments may include a motor 204 powered by any appropriate power source. The motor 204 may utilize petroleum, electricity, and the like. In an exemplary embodiment, the motor 204 may be an electric motor coupled electrically to a power source 206. A current sensor 208 may be coupled to the electric motor 204 or coupled between the electric motor and the power source 206. An electronic static pressure sensor 106 may be located in the flow system 200 downstream of the pump 104. The flow system 200 may further include at least one sample port 116 such that a user may take a sample of the fluid in the flow system. Downstream from the pressure sensor 106, the system 200 may include a filter bypass valve 108. The filter bypass valve 108 may be connected to a first branch 110 and a second branch 112 of the flow system 200. The first branch 110 may include the filter bypass path. The first branch 110 may further include a flow sensor 114. The second branch 112 may include one or more filters 118. The flow system 200 may further include a filter relief valve 120 connected to the second branch 112 in parallel with each corresponding filter 118. A differential pressure sensor 122 may be configured to detect the fluid flow pressure both before and after each corresponding filter 118. Downstream from the one or more filters 118, a back flow check valve 124 may be disposed in the second branch 112. The first branch 110 and second branch 112 may meet upstream of at least one temperature gauge 210. Alternatively or additionally, the flow system 200 may include at least one temperature sensor 212 downstream of the first and second branches 110, 112. Downstream from the at least one of the temperature gauge 210 and the temperature sensor 212, a heat exchanger (or oil cooler in some embodiments) 214 may be disposed in the flow system 200. One or both of a temperature gauge 210 and temperature sensor 212 may be disposed downstream of the heat exchanger 214. The fluid may then pass another flow sensor 114. The fluid may flow downstream from the flow sensor 114 and proceed to an outlet 126.

The current sensor 208 may include a motor on/off sensor. The current sensor 208 may be configured to send a notification if the motor 204 shuts off. In some embodiments, the motor 204 is configured to shut off if a terminal overload switch (not shown) is triggered. The terminal overload switch may be triggered if, for instance, environmental conditions are too hot or if the pressure in the flow system 200 is too high.

The heat exchanger 214 may be configured to alter the temperature of the fluid flowing through the flow system 200. In an exemplary embodiment, the heat exchanger 214 is configured to cool the fluid flowing through the flow system 200. In some embodiments, the heat exchanger 214 may heat or cool the fluid to meet temperature and viscosity requirements for the corresponding product.

The temperature sensors 212 located both upstream and downstream of the heat exchanger 214 may be configured to monitor the temperature of the fluid. In some embodiments, the temperature sensors 212 may be configured to sense the change in fluid temperature due to the heat exchanger 214 to evaluate the functionality of the heat exchanger. In some embodiments that do not include a heat exchanger 214, one or more temperature sensors 212 may be positioned downstream of the filter 118.

In some embodiments, the flow system 200 may further include one or more of the following above referenced components: a particle counter, a magnetic wear debris sensor, a dielectric sensor, global positioning system software/hardware, bar coding, and a moisture sensor. In one embodiment, the heat exchanger 214 may alternatively be located upstream from the pump 104.

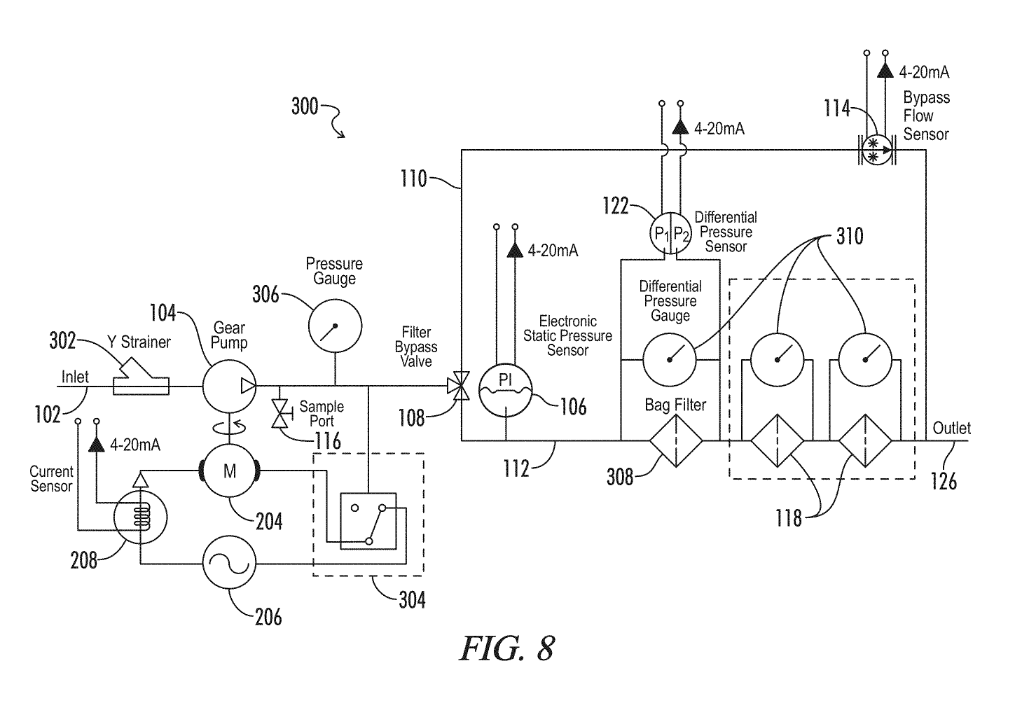

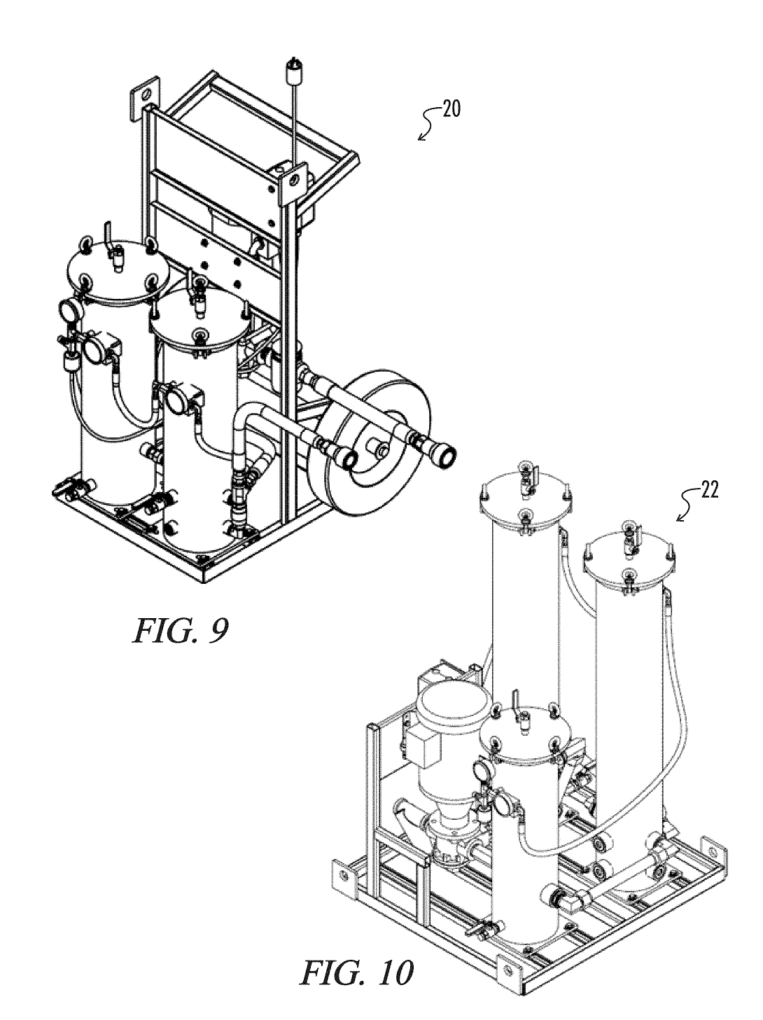

Referring now to FIG. 8, a flow system 300 for devices such as a cart 20 (as shown in FIG. 9) and a stand 22 (as shown in FIG. 10) is shown. As shown in FIG. 8, fluid may enter the flow system 300 through the inlet 102. A Y-strainer 302 may be located downstream of the inlet 102. The Y-strainer 302 may be any appropriate device for mechanically removing unwanted solids from a fluid. Some embodiments of the Y-strainer 302 may include a perforated or wire mesh straining element disposed therein. A pump 104 may be located downstream of the Y-strainer 302. In some embodiments, the pump 104 may be driven either directly or indirectly by a motor 204. In an exemplary embodiment, the motor 204 may be an electric motor coupled electrically to a power source 206. A current sensor 208 may be coupled to the electric motor 204 or coupled between the electric motor and the power source 206. The electric motor 204 may also include a power switch 304 configured to shut the motor off when threshold conditions are exceeded. The flow system 300 may further include at least one sample port 116 such that a user may take a sample of the fluid in the flow system. A pressure gauge 306 may be located downstream of the pump 104 in some embodiments. Downstream from the pressure gauge 306, the system 300 may include a filter bypass valve 108. The filter bypass valve 108 may be connected to a first branch 110 and a second branch 112 of the flow system 300. The first branch 110 may include the filter bypass path. The first branch 110 may further include a flow sensor 114 configured to detect when fluid flows through the first branch in addition to or instead of the second branch 112. The second branch 112 may include an electronic static pressure sensor 106. Downstream of the electronic static pressure sensor 106, the second branch 112 may include a bag filter 308. The bag filter 308 may include any appropriate filter configured to remove particulates out of the fluid. The fluid may flow into a mouth of the bag filter 308 and pass through the material of the bag filter. A differential pressure gauge 310 may be configured to measure the pressure change caused by the bag filter 308. A differential pressure sensor 122 may be configured to detect the fluid flow pressure both before and after the bag filter 308. The second branch 112 may additionally or alternatively include one or more filters 118. Each filter 118 may also include a differential pressure gauge 310 connected in parallel to the second branch 112. Additionally or alternatively, differential pressure sensors 122 may be connected in parallel to the second branch 112 corresponding with each filter 118. The first branch 110 and second branch 112 may then connect and the fluid may proceed to an outlet 126.

In some embodiments, the flow system 300 may further include one or more of the following above referenced components: a particle counter, a magnetic wear debris sensor, a dielectric sensor, global positioning system software/hardware, bar coding, a moisture sensor, and a temperature sensor 212 (downstream from a filter 118 or upstream from the pump 104). In one embodiment, a heat exchanger 214 may be located upstream from the pump 104.

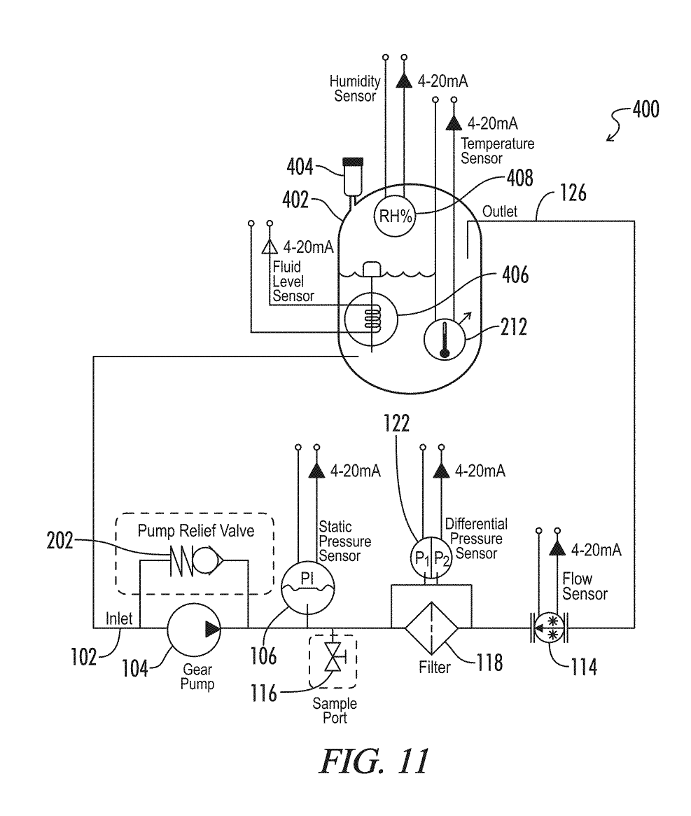

Turning now to FIG. 11, a flow system 400 for devices such as an LT-Series lubricant management system 24 (as shown in FIG. 12) is shown. As shown in FIG. 11, fluid may be contained in a tank 402. The tank 402 may include a fill port 404. The tank 402 may contain a temperature sensor 212, a fluid level sensor 406, a humidity sensor 408, and the like. Fluid may flow from the tank 402 to the inlet 102. A pump 104 may be located downstream of the inlet 102. The flow system 400 may further include a pump relief valve 202 connected in parallel with the pump 104. The pump relief valve 202 may be configured to alleviate excessive pressure produced downstream of the pump 104 due to a clog or some other pressure increasing condition. A static pressure sensor 106 may be located in the flow system 400 downstream of the pump 104. The flow system 400 may further include at least one sample port 116 such that a user may take a sample of the fluid in the flow system. One or more filters 118 may be located downstream from the pressure sensor 106. A differential pressure sensor 122 may be configured to detect the fluid flow pressure both before and after the corresponding filter 118. A flow sensor 114 may be located downstream from the filter 118. Downstream of the flow sensor 114, an outlet 126 may return the fluid to the tank 402.

The fluid level sensor 406 may be configured to detect the volume of the fluid in the tank 402. In some embodiments, the fluid level sensor 406 may produce a signal when the fluid level is below a threshold value. Such an indication may be useful in determining when the tank 402 may need to be refilled. Furthermore, some embodiments may include the fluid level reading produced by the fluid level sensor 406 being input into a calculation that determines filtration time in the flow system 400.

The temperature sensor 212 located in the tank 402 may be configured to measure one or more of the temperature of the fluid in the tank and the temperature of the tank headspace. Additionally, the humidity sensor 408 may be configured to measure the humidity in the tank headspace. These measured values may be used, in some embodiments, to indicate the potential for water contamination in the fluid from water droplet formation inside the tank 402. The humidity sensor 408 may also be configured to measure the amount of water vapor present in the air expressed as a percentage of the amount needed for saturation at the same temperature. In some embodiments, an increase in the relative humidity may indicate a higher chance of water droplet formation in the headspace when the headspace temperature decreases.

The flow system 400 may further include, in some embodiments, a force sensor or weight sensor (not shown) configured to detect the mass of the fluid in the tank 402. Some embodiments may utilize the force or weight sensor to calculate the volume of the fluid in the tank 402. Such calculations can be made taking gravity and/or the density of the fluid into account.

In some embodiments, the flow system 400 may further include one or more of the following above referenced components: a first branch including a bypass branch and a bypass flow sensor, a particle counter, a magnetic wear debris sensor, a dielectric sensor, global positioning system software/hardware, electronic tagging, surface indicia, bar coding, a moisture sensor downstream from the inlet 102 or upstream from the outlet 126, a motor and a corresponding power source and current sensor, and a temperature sensor (downstream from a filter 118 or upstream from the pump 104). In one embodiment, a heat exchanger may be located upstream from the pump 104.

Various combinations of the above mentioned flow systems are contemplated herein. For instance, embodiments may include the flow system 100 including a heat exchanger located upstream from the pump 104. Corresponding temperature sensors may be located before and after the heat exchanger. A relative humidity sensor may be located in the top of a drum in a drum filter cart. The flow system 200 may also, for instance, include a heat exchanger located upstream from the pump 104 with corresponding temperature sensors located before and after the heat exchanger.

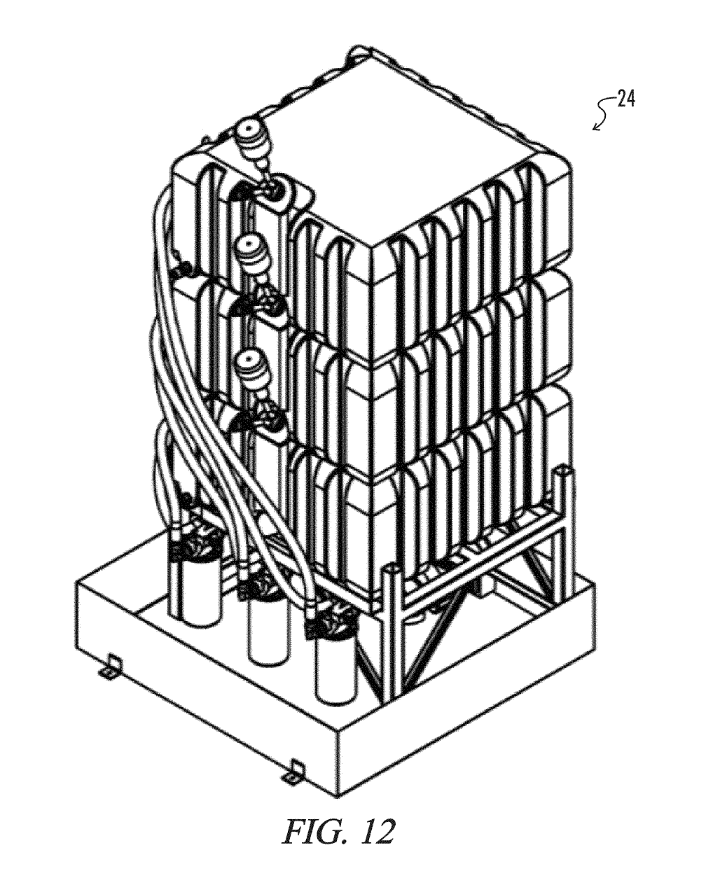

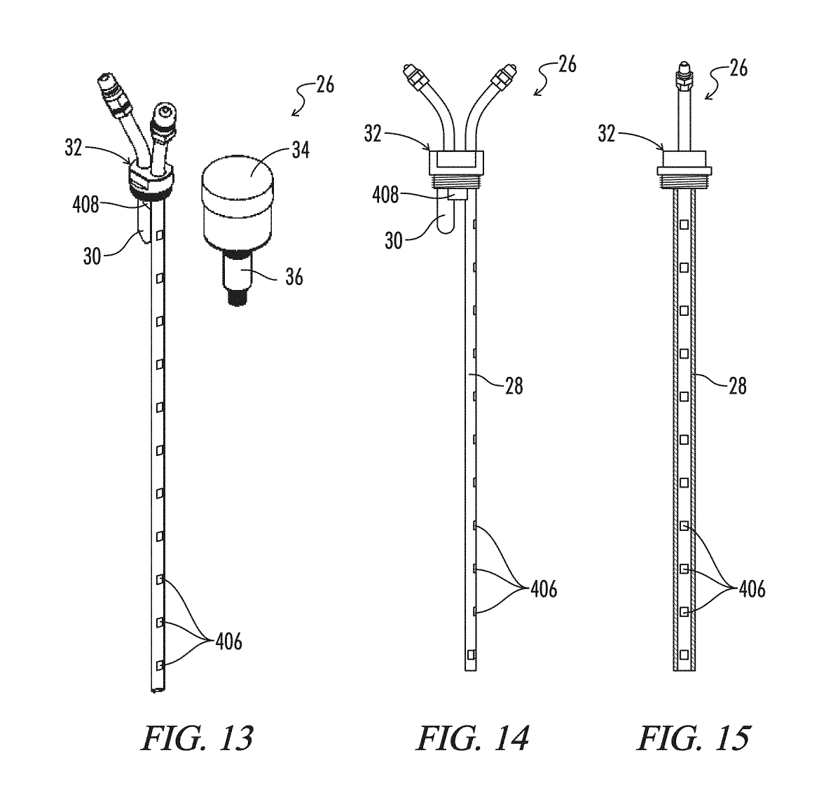

Some embodiments may include a flow system for a drum adapter kit 26 (as shown in FIG. 13). The flow system may include some or all of the components mentioned above including, but not limited to, a level sensor 406 located on or in the drain tube 28 of the drum adapter kit 26, a flow sensor 114 located on or in the fill tube 30, a switch or sensor configured to indicate whether the breather port is open or closed, any form of tagging (bar code, RFID, surface indicia, and the like) to indicate the type of fluid located in the drum or a type of fluid to be used with the adapter kit 26, a global positioning system located on the adapter body 32, any form of tagging (bar code, RFID, surface indicia, and the like) located on the adapter body 32 to indicate the proper corresponding device to use with the adapter kit 26, a relative humidity sensor 408 extending from the bottom of the adapter body 32 and configured to extend into a corresponding drum when the adapter kit 26 is installed, and the like.

As shown in FIGS. 13 and 14, the level sensor 406 may include at least one level sensor disposed on the outside of the drain tube 28. In some embodiments, multiple level sensors 406 may be disposed along the length of the drain tube. The at least one level sensor 406 may include any appropriate sensor. Some non-limiting examples of a level sensor 406 may include a moisture sensor, a dielectric sensor, a pneumatic level sensor, an ultrasonic level sensor, and the like.

Turning now to FIG. 15, the at least one level sensor 406 may additionally or alternatively be disposed on the inside of the drain tube 28. In some embodiments, multiple level sensors 406 may be disposed along the length of the drain tube. The at least one level sensor 406 may include any appropriate sensor.

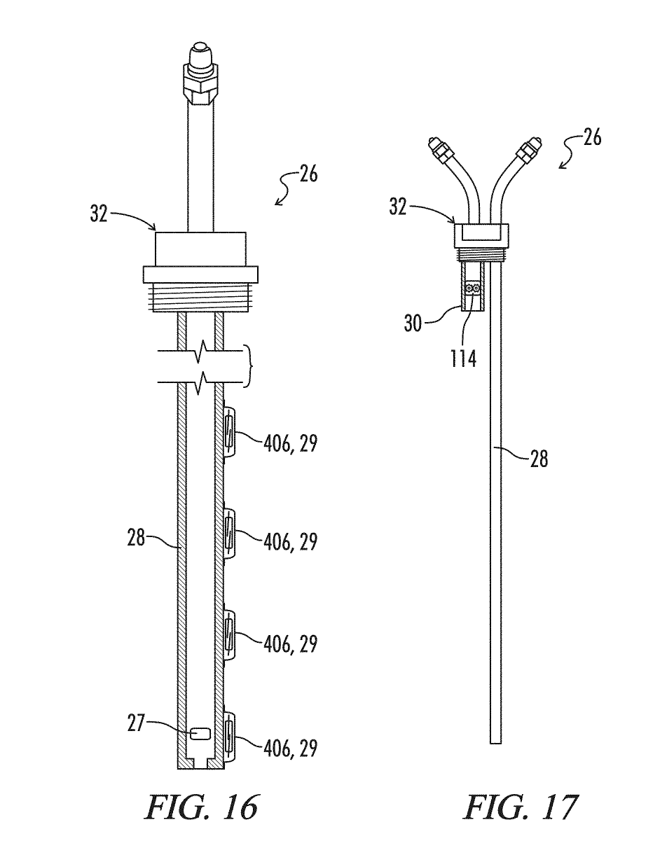

With reference to FIG. 16, the at least one level sensor 406 may include a magnet 27 configured to float on a surface of the oil in a corresponding drum. The at least one level sensor 406 may further include at least one magnetic reed switch 29 disposed along a length L of the drain tube 28. In one embodiment, the at least one magnetic reed switch 29 may be configured to open when the magnet 27 is within a threshold distance from the magnetic reed switch. In another embodiment, the at least one magnetic reed switch 29 may be configured to close when the magnet 27 is within a threshold distance from the magnetic reed switch. A controller (not shown) may receive a signal either that a circuit has been opened or closed at a given magnetic reed switch 29, thereby indicating whether the magnet 27 is near the level of the given magnetic reed switch.

As shown in FIG. 17, the flow sensor 114 of the drum adapter kit 26 may be located on or in the fill tube 30 instead of or in addition to a flow sensor located on or in an outlet hose of a corresponding filtration product.

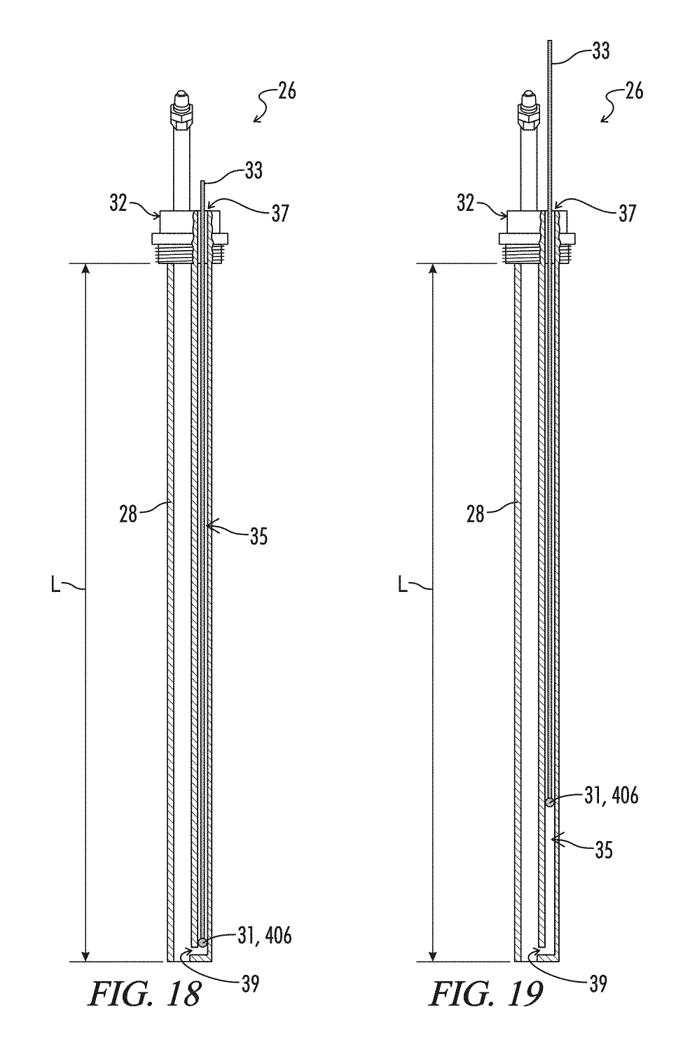

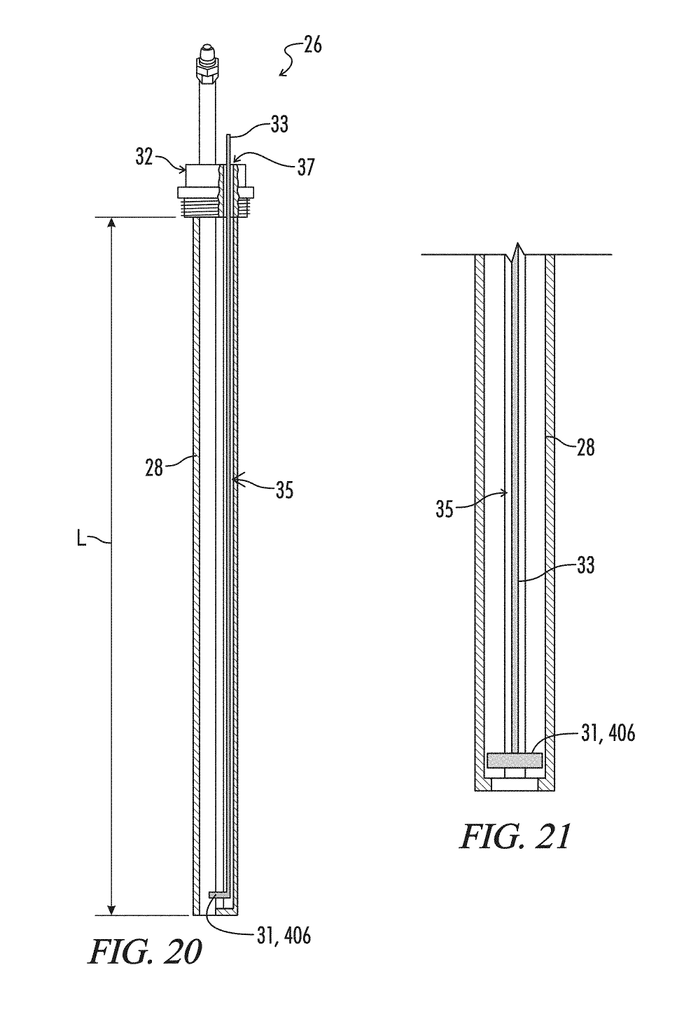

With reference to FIGS. 18-21, the drain tube 28 of the drum adapter kit 26 may be configured, in some embodiments, to reach to the bottom of a connected reservoir (such as a drum) to be filtered. A level indicator placed on the outside of the drain tube 28 or inside the drain tube may indicate when the reservoir is nearly empty. In some embodiments, the adapter kit 26 may be configured to indicate the need to shut off a connected filter cart 14 or drum topper 12 when the reservoir fluid level is lower than a threshold level. The level sensor 406 may include a float 31 configured to float on a surface of the oil in the oil drum. An elongate indication member 33 may be connected to the float 31. The elongate indication member 33 may extend along the length L of the drain tube 28. The elongate indication member 33 may further extend beyond the adapter body 32 to indicate the level of the surface of the oil in the oil drum. The elongate indication member 33 may include surface indicia such that a user may readily ascertain the amount of oil in the oil drum. The elongate indication member 33 may further be rigid or flexible. In further embodiments, the drain tube 28 may include a drain tube wall and an indication member passage 35 defined in the drain tube wall. In such embodiments, the elongate indication member 33 may extend through the indication member passage 35. The adapter body may also include a drum side and an exterior side opposite the drum side. The drain tube may further include an indication member opening 37 nearer the drum side of the adapter body than the exterior side, and the elongate indication member 33 may extend through the indication member opening. As shown in FIGS. 18 and 19, the oil drum adapter kit 26 may further include the float 31 disposed in the indication member passage 35. The indication member passage 35 may further include an oil inlet opening 39 defined in the drain tube wall such that oil may enter the indication member passage and interact with the float 31. As shown in FIGS. 20 and 21, at least a portion of the float 31 may be disposed outside the indication member passage 35, and the indication member passage may include a channel defined in the drain tube wall. The channel may be open to either inside the drain tube 28 or outside the drain tube.

The open/closed switch or sensor of the drum adapter kit 26 may be further configured to detect and/or indicate the breather 34 has been removed or manipulated. The breather 34 may include a breather port, and a switch may be configured to indicate whether the breather is open or closed. The switch may be connected to the breather port, located in the breather, or may be disposed in any other appropriate location.

The tagging of the drum adapter kit 26 may be configured to verify or indicate the correct components (such as the breather 34) are installed on the drum adapter kit. Such tagging may prevent misapplication of the components and may also prevent cross-contamination of the fluids.

The form of tagging (bar code, RFID, surface indicia, and the like) of the drum adapter kit 26 may be configured to be scanned by a corresponding scanner, received wirelessly by another computer, read by a user, or the like. The tagging may serve as an indicator of a list of compatible filter carts 10 and fluids that may be properly connected to the drum, tote, or reservoir to which the drum adapter kit 26 is installed. Such a system may aid in preventing cross-contamination of the fluids. The tagging may also provide information such as the type of breather 34 to be used with the drum adapter kit 26 such that a user may avoid installing an incorrect or incompatible breather on the adapter kit or associated device. The tagging may additionally or alternatively provide information such as the size and type of the quick connection assembly 36 to be used with the drum adapter kit 26 such that a user may be able to avoid retrieving an incorrectly sized part.

Many of the above mentioned drum adapter kit 26 embodiments may allow for one or more sensors to be mounted in appropriate locations with regard to an oil drum without altering the oil drum. Such a configuration may be desirable because the oil drums may be interchangeable. Mounting sensors directly to such oil drums may prove to be overly expensive in many applications.

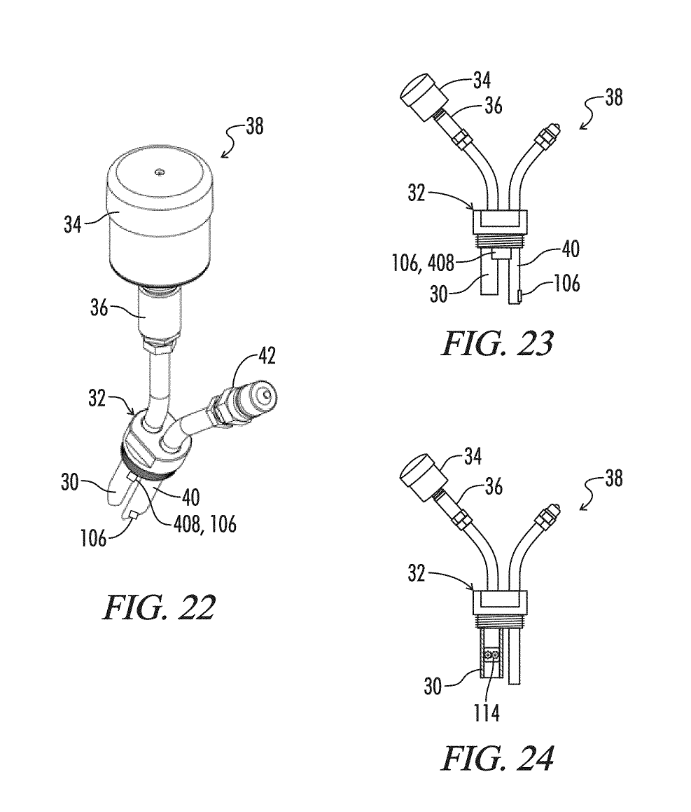

Some embodiments may include a flow system for an oil tote adapter kit 38 (as shown in FIGS. 22-24). The flow system may include some or all of the components mentioned above including, but not limited to, a pressure sensor 106 or pressure gauge 306 located on or in the drain passage 40 or drain connection 42, a flow sensor 114 located on or in the fill tube 30 (shown in FIG. 24), a switch or sensor configured to indicate whether the breather port is open or closed (located, in some embodiments, on or in the breather 34), any form of tagging (bar code, RFID, surface indicia, and the like) to indicate the type of fluid located in the tote or a type of fluid to be used with the tote adapter kit 38, a global positioning system located on the adapter body 32, any form of tagging (bar code, RFID, surface indicia, and the like) located on the adapter body 32 to indicate the proper corresponding device to use with the tote adapter kit 38, a relative humidity sensor 408 extending from the bottom of the adapter body 32 and configured to extend into a corresponding tote when the tote adapter kit 38 is installed (shown in FIGS. 22 and 23), and the like.

A pressure sensor 106 may be disposed on the drain passage 40 and may be configured to sense a pressure experienced due to the oil in the oil tote. The pressure sensor 106 may further be connected to a controller. The controller may convert a pressure sensed by the pressure sensor 106 to a fluid level value if the density of the fluid is input into the calculations. A second pressure sensor 106 may be disposed on the adapter body 32 and may be configured to sense the pressure in the reservoir headspace. A breather 34 may be connected to the fill tube 30. The breather 34 may include at least one check valve. In embodiments having both the first and second pressure sensors 106, the controller may be further configured to compare the results of the two pressure sensors to account for pressure effects experienced due to the breather 34 and the at least one check valve in calculating the oil level contained in the oil tote.

As stated above, the oil tote adapter kit 38 may include an open/closed switch or sensor configured to detect and/or indicate the breather 34 has been removed or manipulated. The breather 34 may include a breather port, and a switch may be configured to indicate whether the breather is open or closed. The switch may be connected to the breather port, located in the breather, or may be disposed in any other appropriate location.

Many of the above mentioned oil tote adapter kit 38 embodiments may allow for one or more sensors to be mounted in appropriate locations with regard to an oil tote without altering the oil tote. Such a configuration may be desirable because the oil totes may be interchangeable. Mounting sensors directly to such oil totes may prove to be overly expensive in many applications.

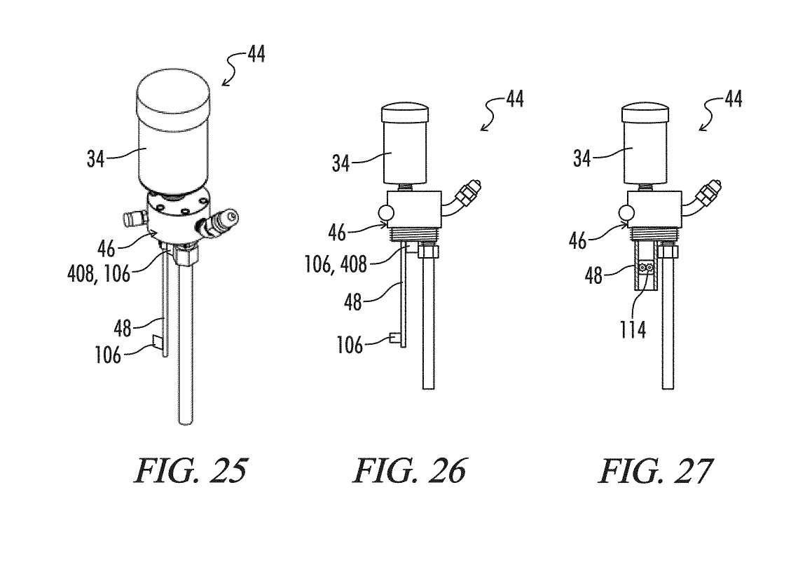

Some embodiments may include a flow system for a hydraulic or gearbox adapter kit 44 (as shown in FIGS. 25-27). The flow system may include some or all of the components mentioned above including, but not limited to: a pressure sensor 106, pressure gauge 306, or vacuum sensor located in any appropriate location such as on or in the adapter body 46; a flow sensor 114 located on or in the fill tube 48 (shown in FIG. 27); a switch or sensor configured to indicate whether the breather port is open or closed (located, in some embodiments, on or in the breather 34 or the breather port); any form of tagging (bar code, RFID, surface indicia, and the like) to indicate the type of fluid located in the gearbox or a type of fluid to be used with the hydraulic/gearbox adapter kit 44; a global positioning system located on the adapter body 46; any form of tagging (bar code, RFID, surface indicia, and the like) located on the adapter body 46 to indicate the proper corresponding device to use with the hydraulic/gearbox adapter kit 44; a relative humidity sensor 408 disposed on the bottom of the adapter body 46 and configured to extend into a corresponding headspace of the hydraulic system or gearbox when the hydraulic/gearbox adapter kit 44 is installed; and the like.

The pressure sensor 106 or vacuum sensor may, in some embodiments, replace a vacuum indicator. The pressure sensor 106 or vacuum sensor may be configured to detect a pressure inside the hydraulics system or gearbox and indicate if the filter element within the breather 34 is clogged or otherwise defective. The sensor 106 may also indicate if the breather 34 utilized in the flow system is under-sized for the application. In some embodiments, the pressure sensor 106 may be disposed on the adapter body 46.

As stated above, the hydraulic or gearbox adapter kit 44 may include an open/closed switch or sensor of the drum adapter kit 26 may be further configured to detect and/or indicate the breather 34 has been removed or manipulated. The breather 34 may include a breather port, and a switch may be configured to indicate whether the breather is open or closed. The switch may be connected to the breather port, located in the breather, or may be disposed in any other appropriate location.

Many of the above mentioned hydraulic system or gearbox adapter kit 44 embodiments may allow for one or more sensors to be mounted in appropriate locations with regard to a hydraulic system or gearbox without altering the hydraulic system or gearbox. This configuration may allow for relatively easily installed retrofit sensor systems.

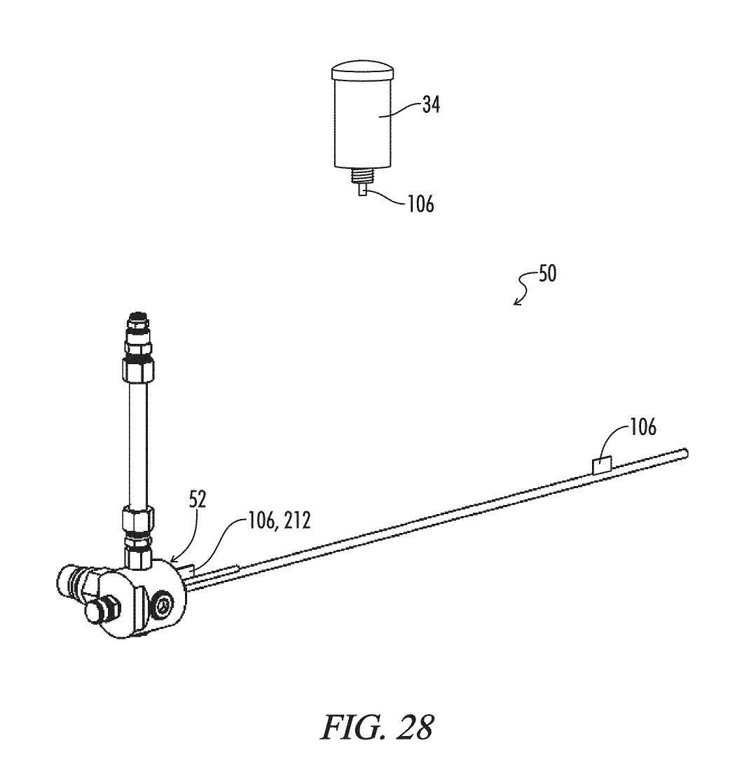

Some embodiments may include a flow system for a drain port adapter kit 50 to be connected to industrial equipment (as shown in FIG. 28). The flow system may include some or all of the components mentioned above including, but not limited to: a pressure sensor 106 or pressure gauge 306 located in any appropriate location such as on or in the drain tube 53; one or more temperature sensors 212 configured to extend into the reservoir from the inside of the adapter body 52; any form of tagging (bar code, RFID, surface indicia, and the like) located on the adapter body 52 to indicate the proper corresponding device to use with the drain port adapter kit 50; and the like.

A pressurizing breather 34 can cause an internal pressure measuring sensor 106 to indicate a false reading. The flow system for the drain port adapter kit 50 may use the pressure sensor 106 disposed on the drain tube 53 to sense a pressure experienced due to the oil in the industrial equipment, and one or more pressure sensors in the headspace of the industrial equipment and/or breather 34 may sense a pressure in the headspace. A controller may be configured to compare the pressures sensed by the two or more pressure sensors 106 to correct for any pressure differences due to the breather 34 or other factors. The controller may then be configured to determine an accurate fluid level measurement. This task may be accomplished, in some embodiments, even when the system has a pressurizing breather 34 at its venting location. In some embodiments, the controller may be further configured to receive a density of the oil as an input from a user. Then, the controller may be configured to calculate the level of the oil in the industrial equipment based on the pressures sensed by the at least two pressure sensors 106.

The flow system for a drain port adapter kit 50 may also be configured, in some embodiments, to compare the moisture content in the fluid to the moisture content in the desiccant breather 34 to determine where moisture may be entering the flow system. Some embodiments may simply monitor the trend in moisture increases or decreases in both the fluid and the breather 34. Such a capability may aid in diagnosing potential issues in the flow system.

Many of the above mentioned drain port adapter kit 50 embodiments may allow for one or more sensors to be mounted in appropriate locations with regard to a drain port of industrial machinery or other containers without altering the industrial machinery or container. This configuration may allow for relatively easily installed retrofit sensor systems.

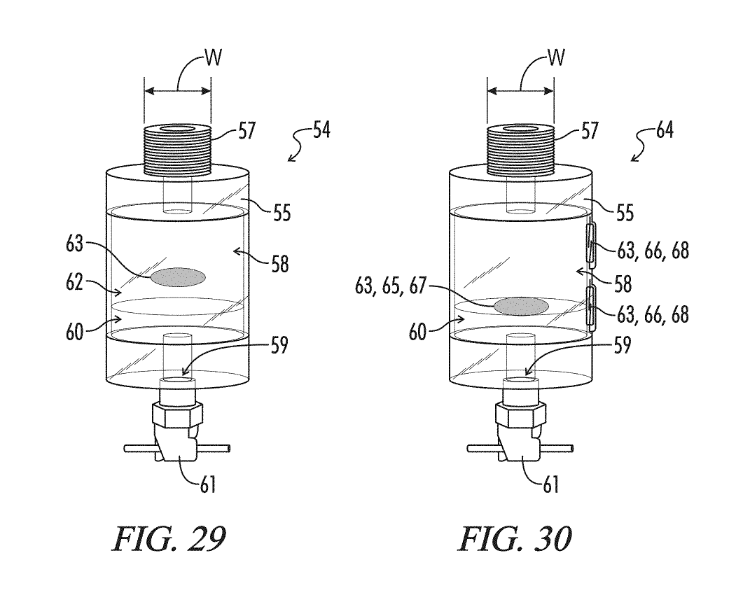

Some embodiments may include an oil sight glass 54 (as shown in FIG. 29) and corresponding sensors for monitoring oil in a container, industrial equipment, or a piece of machinery. Although discussed herein as an “oil sight glass” the various embodiments of the apparatus shown in FIGS. 29-33 may further be described as a “bottom sediment glass” or “water bowl”. The oil sight glass 54 may include a sight glass body 55. The sight glass body 55 may include a transparent material. A threaded connector 57 may be disposed on the sight glass body 55. The threaded connector 57 may be configured to attach the sight glass 54 to the container. The sight glass body 55 may further include a drain port 59 defined therein. A drain port valve 61 may be connected to the sight glass body 55 and may be configured to open and close the drain port 59. A cavity 62 may be defined in the sight glass body 55. The cavity 62 may be configured to contain a sample of the oil 58. In some embodiments, the cavity 62 may also be configured to contain any free water 60 from inside the container. At least one sensor 63 may be contained in the cavity 62 and may be unattached from the sight glass body 55. The at least one sensor 63 may be configured to remain at least partially submerged in the sample of the oil 58. The sensor 63 may include any appropriate material, but one embodiment may include plastic with appropriate weights attached thereto. Other embodiments may include the sensor 63 made of an appropriate metal of a size and shape that allows the sensor to function without the addition of weights. In some embodiments, the sensor 63 may include a battery powered wireless sensor. Of course, other embodiment including one or more wires connected to the sensor 63 are contemplated. These wires may include power wires and/or data carrying wires. In many embodiments, the sensor 63 may include a moisture sensor configured to detect a percentage of moisture in the sample of the oil 58 from, for instance, contamination by dissolved or emulsified water. In some embodiments, the sensor 63 may include a temperature sensor. The sensor 63 in these embodiments may be configured to detect a temperature of the sample of the oil 58.

Turning now to FIG. 30, an oil sight glass 64 may include many of the above described features. The oil sight glass 64 may also include a sensor 63 at least partially disposed in the cavity 62. At least a portion of the sensor 63 may be configured to float on free water 60 and sink in oil 58. In some embodiments, the sensor 63 may be configured to maintain an upright orientation. Stated another way, the sensor 63 may be sized and shaped such that it maintains an appropriate orientation in the cavity 62 of the oil sight glass 64 regardless of how the oil sight glass is handled. The sensor 63 in these embodiments may include a moisture sensor disposed on the sensor in a location to come into contact with only the oil 58 when the sensor is in the upright position. The sensor 63 may be configured to detect a percentage of moisture in the sample of the oil 58. The sensor 63 may be further configured to detect moisture in the oil 58 due to contamination of the oil with dissolved or emulsified water 60. In many embodiments, the sensor 63 may include a floating component 65 and a stationary component 66. The floating component 65 may be configured to float on the free water 60 and to sink in the oil 58. The floating component 65 may include any appropriate material, but one embodiment may include plastic with appropriate weights attached thereto. Other embodiments may include the floating component 65 made of an appropriate metal of a size and shape that allows the floating component to function without the addition of weights. Generally, the floating component may have a density of greater than about 800 kilograms per cubic meter and less than about 1000 kilograms per cubic meter. Optional embodiments may include glass fibers for achieving the appropriate density of the separator. Different polymers may also be used, such as high density polyethylene or polypropylene. The stationary component 66 may be disposed on the sight glass body 55. The stationary component 66 may be mounted on the sight glass body 55 inside the cavity 62, within the wall of the sight glass body, or on the outside of the sight glass body. In the embodiment of the oil sight glass 64 in FIG. 30, the floating component 65 may include a magnet 67 and the stationary component 66 may include at least one magnetic reed switch 68. In one embodiment, the at least one magnetic reed switch 68 may be configured to open when the magnet 67 is within a threshold distance from the magnetic reed switch. In another embodiment, the at least one magnetic reed switch 68 may be configured to close when the magnet 67 is within a threshold distance from the magnetic reed switch. A controller (not shown) may receive a signal either that a circuit has been opened or closed at a given magnetic reed switch 68, thereby indicating whether the magnet 67 is near the level of the given magnetic reed switch. The controller may then calculate the level of free water 60 in the cavity 62. This value may be used as a reference value that may be representative of the amount of free water in the container. The oil sight glass 64 may further include the threaded connector 57 having a minimum passage width W. The floating component 65 may be larger than the minimum passage width W so the floating component does not enter the container. In such embodiments, the oil sight glass 64 may have a removable bottom such that the floating component 65 may be installed or removed.

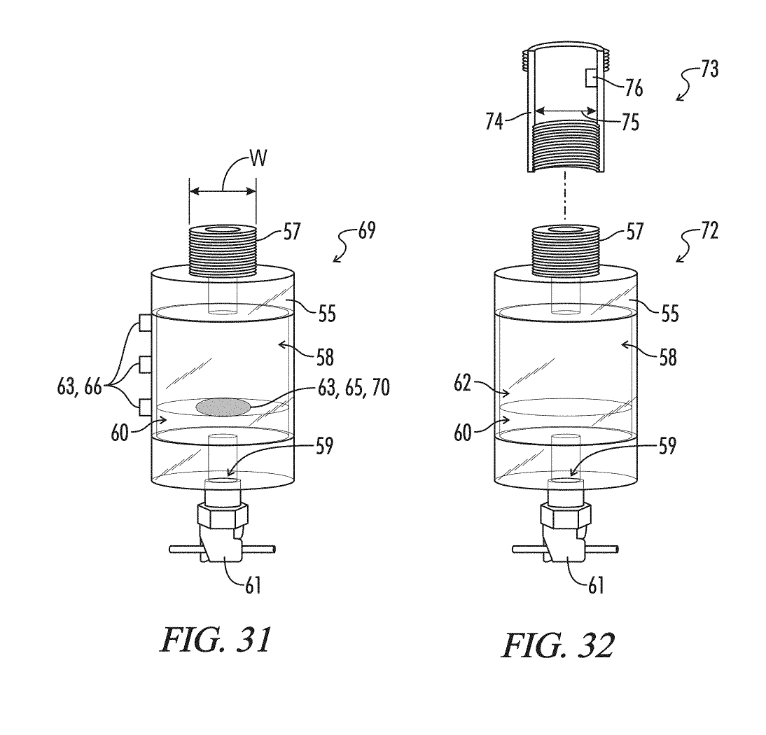

FIG. 31 shows another embodiment of the oil sight glass 69 that has many features in common with the oil sight glass 64 of FIG. 30. Additionally or alternatively, the sensor 63 may include a floating component 65 having at least one RFID chip 70. The sensor 63 may additionally or alternatively further include a stationary component 66 having at least one RFID sensor 71. A controller may receive a signal from a given RFID sensor 71 when the sensor detects the RFID chip 70, thus indicating a level of the free water 60 in the cavity 62. In some embodiment, the RFID chip 70 may be a self-powered, or active, RFID chip. In other embodiments, the RFID chip 70 may be an externally powered, or passive, RFID chip. In still further embodiments, the floating component 65 may include at least one RFID sensor 71 and the stationary component 66 may include at least one RFID chip 70. Other sensor configurations are also considered herein, including, but not limited to, optical sensors with a corresponding easily spotted flag component, ultrasonic sensors with a sound reflector component, capacitive sensors or dielectric sensors, and the like.

FIG. 32 shows another embodiment of an oil sight glass 72. The oil sight glass 72 may include many features similar to those mentioned above. Additionally or alternatively, the oil sight glass 72 may be included in an oil sight glass assembly 73. The oil sight glass assembly 73 may include the oil sight glass 72 and an extension tube 74. The extension tube 74 may be configured to mount to a container at a port of the container. The extension tube 74 may include an internal passageway 75 and at least one sensor 76 configured to extend into the internal passageway. The at least one sensor 76 may be mounted to the inside of the extension tube 74, may be mounted to the outside of the extension tube and extend through the tube into internal passageway 75, and the like. In such embodiments, the oil sight glass 72 may include a sight glass body 55 connected to the extension tube 74. Many embodiments include the threaded connector 57 of the oil sight glass 72 threadingly received in the internal passageway 75 of the extension tube 74. Various sensor types are contemplated for the sensor 76 disposed in the extension tube 74. The sensor 76 may include, for instance, a temperature sensor configured to detect a temperature of the sample of the oil, a moisture sensor configured to detect a percentage of moisture in the sample of the oil due to contamination of the oil with dissolved or emulsified water, and the like.

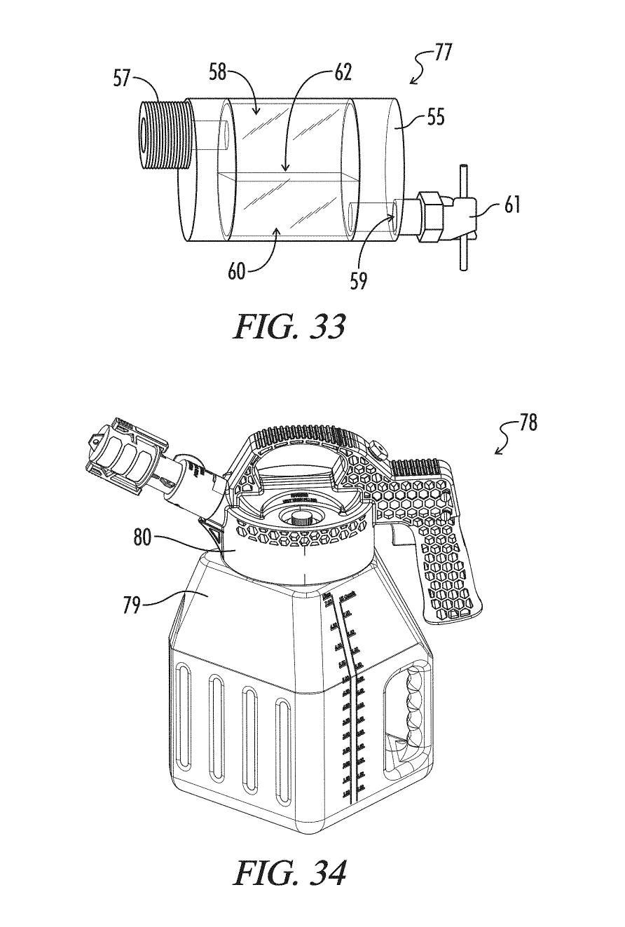

FIG. 33 shows another optional version of an oil sight glass 77. Any of the above described embodiments of an oil sight glass may be adapted to function properly with an oil sight glass such as that shown in FIG. 33.

The various embodiments of oil sight glasses described above can have many benefits. The oil sight glass embodiments may allow for easier cleaning of the oil sight glass without concern for potentially ruining components of the oil sight glass with a water or weak acid bath. The oil sight glass embodiments also may allow a user to choose from inspecting the oil sight glass in person or with a computer, mobile device, and the like. The oil sight glass embodiments further still allow a user to retrofit appropriate sensors on a container or piece of machinery with relatively little effort.

Some embodiments may include a fluid transfer container 78 (as shown in FIG. 34), such as the DES-CASE ISOLINK oil transfer container and corresponding sensors. A global positioning system device may be located on the container body 79 or the dispensing lid 80. The GPS may be configured to show the location of the container 78 on a corresponding display unit. Such a feature may be useful, in some embodiments, to verify the compatibility of the fluid to the container 78 to avoid cross-contamination. A fluid level sensor 406 may be disposed in the container body 79 and may be configured to detect and/or indicate a corresponding level of the fluid inside the container 78. The container 78 may further include any form of tagging (bar code, RFID, surface indicia, and the like) located in any appropriate position, such as the dispensing lid 80. The tagging may be configured to indicate the type of fluid located in the container 78 or a type of breather 34 that corresponds to the container to prevent misapplication of the breather and to prevent cross-contamination of the fluids.

Some embodiments may include a grease gun of any appropriate construction including one or more sensors. The sensors may be configured to indicate the type of grease contained in the grease gun. The sensors may also be configured to indicate the volume of grease contained in the grease gun.

Any or all of the above electronic devices may communicate either wirelessly or through a wired connection to a central database. The information transmitted thereto may indicate various states of sensors, locations of devices, problems associated with components of the flow systems, and the like. The central database may be located in the same facility as the electronic devices described above, or may be a remote central database. The central database may be configured to further calculate and/or compile the information received from the various electronic devices, or may simply catalogue all incoming information for later viewing by a user or separate calculating component.

Other combinations of the above devices, flow systems, sensors, and other components are contemplated herein. Any appropriate combination may be made by adding, subtracting, and/or replacing portions of one embodiment with portions of another embodiment to form yet another embodiment.

This written description uses examples to disclose the invention and also to enable any person skilled in the art to practice the invention, including making and using any devices or systems. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although embodiments of the disclosure have been described using specific terms, such description is for illustrative purposes only. The words used are words of description rather than limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. While specific uses for the subject matter of the disclosure have been exemplified, other uses are contemplated. Therefore, the spirit and scope of the appended claims should not be limited to the description of the versions contained herein.

What is claimed is:

1. An oil drum adapter kit for connection to an oil drum, the oil drum adapter kit comprising:
an adapter body;
a fill tube connected to the adapter body configured to allow the oil drum to be filled with oil;
a drain tube connected to the adapter body configured to allow oil to be removed from the oil drum; and
a level sensor disposed on the drain tube, the level sensor for determining a level of oil contained in the oil drum.

2. The oil drum adapter kit of claim 1, wherein the level sensor is disposed on the outside of the drain tube.

3. The oil drum adapter kit of claim 1, wherein the level sensor is disposed on the inside of the drain tube.

4. The oil drum adapter kit of claim 1, wherein the level sensor includes:
a float configured for floating on oil; and
an elongate indication member connected to the float, the elongate indication member extending along the drain tube and beyond the adapter body to indicate a level of oil in the oil drum.

5. The oil drum adapter kit of claim 4, wherein:
the drain tube includes:
a drain tube wall; and
an indication member passage defined in the drain tube wall; and
the elongate indication member extends through the indication member passage.

6. The oil drum adapter kit of claim 5, wherein:
the adapter body includes a drum side and an exterior side opposite the drum side;
the drain tube further includes an indication member opening nearer the drum side of the adapter body than the exterior side; and
the elongate indication member extends through the indication member opening.

7. The oil drum adapter kit of claim 5, wherein:
the float is disposed in the indication member passage; and
the indication member passage includes an oil inlet opening defined in the drain tube wall configured so oil may enter the indication member passage and interact with the float.

8. The oil drum adapter kit of claim 5, wherein:
the indication member passage includes a channel defined in the drain tube wall.

9. The oil drum adapter kit of claim 1, wherein the level sensor includes:
a magnet configured to float on a surface of oil; and
at least one magnetic reed switch disposed along the drain tube, the at least one magnetic reed switch configured to open or close a circuit in the presence of the magnet.

10. The oil drum adapter kit of claim 1, further comprising:
a flow sensor disposed inside the fill tube.

11. The oil drum adapter kit of claim 1, further comprising:
a relative humidity sensor connected to the adapter body to sense relative humidity in a headspace of the oil drum when the adapter kit is mounted on the oil drum.

12. The oil drum adapter kit of claim 1, further comprising:
a breather connected to the fill tube, the breather including a breather port;
a switch configured to indicate whether the breather port is open or closed.

13. A drain port adapter kit for connection to industrial equipment, the drain port adapter kit comprising:
an adapter body;
a drain tube connected to the adapter body to allow oil to be removed from the industrial equipment;
a pressurizing breather configured to be in fluid communication with air in a headspace of the industrial equipment;
a first pressure sensor disposed on the drain tube, the first pressure sensor configured to sense a pressure experienced due to oil in the industrial equipment;
a second pressure sensor configured to sense a pressure in the headspace; and
a controller configured to compare pressures sensed by the first pressure sensor with pressures sensed by the second pressure sensor to correct for any pressure differences in the headspace due to the pressurizing breather.

14. The drain port adapter kit of claim 13, wherein the controller is further configured to receive a density of oil as an input and to calculate the level of oil in the industrial equipment based on the pressures sensed by the first pressure sensor and the pressures sensed by the second pressure sensor.

15. An oil sight glass for monitoring oil and water in a container, the oil sight glass comprising:
a sight glass body including a transparent material;
a threaded connector disposed on the sight glass body, the threaded connector configured to attach the sight glass to the container;
a drain port defined in the sight glass body;
a drain port valve connected to the sight glass body to open and close the drain port;
a cavity defined in the sight glass body, the cavity configured to contain a sample of the oil and the water; and
a sensor at least partially disposed in the cavity, at least a portion of the sensor configured to float on free water and sink in oil.

16. The oil sight glass of claim 15, wherein:
the sensor is configured to maintain an upright orientation; and
the sensor includes a moisture sensor configured to detect a percentage of moisture in the sample of the oil, the moisture sensor further configured to remain submerged in oil when the sensor is in the upright orientation.

17. The oil sight glass of claim 15, wherein the sensor includes:
a floating component configured to float on the free water and sink in oil; and
a stationary component mounted to the sight glass body.

18. The oil sight glass of claim 17, wherein the floating component includes an RFID chip and the stationary component includes at least one RFID sensor.

19. The oil sight glass of claim 17, wherein the floating component includes a magnet and the stationary component includes at least one magnetic reed switch.

20. The oil sight glass of claim 17, wherein:
the threaded connector includes a minimum passage width; and
the floating component is larger than the minimum passage width.
